(19) United States
(12) Patent Application Publication
(10) Pub. No.: US 2024/0423139 A1
(43) Pub. Date: Dec. 26, 2024

(54) Flower Funnel Device

(71) Applicant: Carol Bartlett, East Jordan, MI (US)

(72) Inventor: Carol Bartlett, East Jordan, MI (US)

(21) Appl. No.: 18/747,537

(22) Filed: Jun. 19, 2024

Related U.S. Application Data
(60) Provisional application No. 63/509,058, filed on Jun. 20, 2023.

(51) Int. Cl. A01G 5/02; B65B 25/02; B65B 67/08

(52) U.S. Cl. CPC A01G 5/02; B65B 25/023; B65B 67/08

(57) ABSTRACT

A flower funnel device is provided. The device is comprised of a funnel body, a ribbon, and a stand. The funnel body is placed inside of the stand during floral arrangement and securely holds in place the flowers in use. The stand is placed on a flat surface, permitting hands-free flower manipulation. Upon completion of the arrangement, a ribbon that has been pre-placed inside of the stand is used to tie a knot around the stems of the flowers, allowing for the safe removal of the bouquet.

### CROSS-REFERENCE TO RELATED APPLICATION

The present application claims priority to, and the benefit of, U.S. Provisional Application No. 63/509,058, which was filed on Jun. 20, 2023, and is incorporated herein by reference in its entirety.

### FIELD OF THE INVENTION

The present invention relates generally to the field of flower bouquets. More specifically, the present invention relates to a flower funnel device capable of securing flowers on a flat surface while a florist arranges them to their desired positions. Accordingly, the present disclosure makes specific reference thereto. Nonetheless, it is to be appreciated that aspects of the present invention are also equally applicable to other like applications, devices, and methods of manufacture.

### BACKGROUND

Floral arrangement is tedious and methodical, requiring the undisturbed attention and aesthetic eye of a skilled florist. Often, a florist may need to use both hands to arrange their bouquet in a desired manner but are inhibited by the need to hold the flowers together in one hand. Additionally, florists often need to step back and observe their creations to perceive the full effect of their work. The need to hold the bouquet in one hand while trying to observe the perceived effect of the arrangement can make this a difficult process. Lastly, tying a ribbon around a finished floral arrangement requires two hands. Often, it may be necessary for a florist to lay their bouquet down on a flat surface in order to use two hands to tie a knot around the stems of their flowers, risking damage to the arrangement.

Therefore, there exists a long-felt need in the art for a flower funnel device that holds flowers in place hands-free during the arrangement process. More specifically, there exists a long-felt need in the art for a flower funnel device that can stand on a table or flat surface and maintain the shape of a bouquet during the arrangement. Furthermore, there exists a long-felt need in the art for a flower funnel device that features a ribbon in the funnel body that permits easy two-handed tying of a knot around the stems of a completed floral arrangement, eliminating the risk of damage to the flower heads.

The subject matter disclosed and claimed herein, in one embodiment thereof, comprises a flower funnel device. The device is comprised of a funnel body, a ribbon, and a stand. The device can be placed on a table or flat surface, with the funnel body placed inside of the stand. The funnel body then receives and holds in place flowers as the florist arranges them throughout the creative process. Once the flowers have been arranged in the florist's desired position, a ribbon that has been pre-placed within the funnel body and exposed through an opening is tied around the stems of the flowers.

In this manner, the flower funnel device of the present invention accomplishes all the foregoing objectives and provides a device that permits the hands-free arrangement of flowers without risking damage to the flower heads. More specifically, the flower funnel body device can be placed on a flat surface and hold flowers fixed in place while a pre-placed ribbon is present and can be tightened around the stems, permitting safe removal from the funnel body.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a flower funnel device comprised of a funnel body, a ribbon, and a stand. The device is designed to be placed on a table or flat surface, while the funnel body holds in place a bouquet of flowers, which is either fixedly or removably attached to the stand and secured together by the tying of a ribbon around the stems of the flowers once the florists' desired arrangement has taken place.

The funnel body is preferably made from a plastic or silicone material that securely and easily maintains the shape of the desired flower arrangement without fear of breaking, cracking, or falling. In differing embodiments, the funnel body is preferably of an exposed cone shape, where the apex is removed to fit a suitable size of flower stems. In differing embodiments, the funnel body may be comprised of transparent plastic material, such that the florist may be able to easily visualize the stems connected to the heads of the flowers for arrangement case. The stand is preferably comprised of a heavier material so that any knocking or shaking of a table will not disturb the arrangement. Such materials may include, but not be limited to, denser plastic or metal.

During use, the flowers are placed in the interior space of the funnel body permitting hands-free arrangement. Furthermore, the funnel body features an opening where a ribbon may drape down from. Once the flowers have been placed inside the interior space of the funnel body and arranged to their desired position, the ribbon is used to tie the stems of the flowers together for secure arrangement. Because tying a ribbon requires two hands, this feature is particularly advantageous, as the florist no longer needs to hold the bouquet in one hand while trying to fasten the arrangement together in another. The device also features a stand that may be fixedly or removably attached to the funnel body and may be of any shape that can be stably placed on a table or flat surface and is preferably of a weight that inhibits unwanted movement or falling during the arrangement process.

Furthermore, in differing embodiments, the funnel body may not be one continuous piece but instead feature a hinge with at least one fastener on each edge of the funnel body. This permits the removal of the flowers from the funnel body without being pulled out from the top, risking damage to the arrangement. The fasteners may be comprised of any fastening mechanism known in the art but are preferably buttons.

The present invention is also comprised of a method of using the device. First, a device is provided comprised of a funnel body, a ribbon, and a stand. Then, the funnel body is positioned inside the stand such that it can securely hold a bouquet of flowers, allowing for a hands-free floral arrangement. Next, a ribbon is tightened around the stems of the flowers to securely form a bouquet that will not fall apart upon removal from the funnel body.

Accordingly, the flower funnel device of the present invention is particularly advantageous as it provides a device that permits the hands-free arrangement of flowers without risking damage to the flower heads. More specifically, the flower funnel body device can be placed on a flat surface and hold flowers fixed in place while a pre-placed ribbon is present and can be tightened around the stems, permitting safe removal from the funnel body. In this manner, the flower funnel device provides a solution to allowing a user to easily form a bouquet of flowers.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a flower funnel device of the present invention with a ribbon fed through the body in accordance with the disclosed architecture;

FIG. 2 illustrates a perspective view of one potential embodiment of a body of a flower funnel device of the present invention while open in accordance with the disclosed architecture;

FIG. 3 illustrates a perspective view of one potential embodiment of a flower funnel device of the present invention with flowers and a ribbon within the body in accordance with the disclosed architecture; and

FIG. 4 illustrates a flowchart of a method of using one potential embodiment of a flower funnel device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a flower funnel device that holds flowers in place for a florist to arrange them hands-free. More specifically, there exists a long-felt need in the art for a flower funnel device that features a weighted stand with a fixed or removable attachment to the funnel body for ideal floral arrangement needs. Additionally, there exists a long-felt need in the art for a flower funnel device that features an exposed ribbon so that the stems of the flowers may be tightened and secured once proper arrangement has taken place.

The present invention, in one exemplary embodiment, is comprised of a flower funnel device. The device is comprised of a funnel body, a ribbon, and a stand. The device is designed to be placed on a table or flat surface, with the funnel body exposed at the top, fit for a bouquet of flowers to be placed into. Once the flowers have been arranged in the florist's desired position, a ribbon that has been pre-placed within the funnel body and exposed through an opening is tied around the stems of the flowers.

More specifically, the device is comprised of a funnel body that is preferably of a plastic or silicon material. In differing embodiments, the funnel body may be comprised of a transparent plastic material so that the flower stems may be seen as they are connected to their respective flower heads. Furthermore, in differing embodiments, the funnel body may be one continuous piece, or feature a fastening mechanism on two edges of the funnel body to open the funnel body. This embodiment permits the removal of the arranged flowers from the funnel body horizontally, as opposed to having to pull them vertically up out of the funnel, risking potential detriment to the petals of the flower heads. Additionally, the device features a stand that may be fixedly or removably attached to the funnel body in differing embodiments and may be easily placed on a table or flat surface during arrangement without risk of falling or wavering.

During use, the interior space of the funnel body holds the flowers present for arrangement, permitting a hands-free creative process. Once the flowers have been arranged to their desired position, a ribbon that is exposed through an opening in the funnel body is used to tie the stems of the flowers together for secure arrangement. This feature is particularly advantageous, as the florist no longer needs to hold the bouquet in one hand while trying to fasten the arrangement together in another. The device also features a stand that may be fixedly or removably attached to the funnel body and may be of any shape that can be stably placed on a table or flat surface and is preferably of a weight that inhibits unwanted movement or falling during the arrangement process.

Furthermore, in differing embodiments, the flowers may be removed from the funnel body without being pulled out from the top, risking damage to the arrangement, but instead be removed horizontally, through a hinge in the funnel body. In this embodiment, the funnel body may not be one continuous piece but instead feature an opening with at least one fastener on each edge of the funnel body. The fasteners may be comprised of any fastening mechanism known in the art but are preferably buttons.

The present invention is also comprised of a method of using the device. First, a device is provided comprised of a funnel body, a ribbon, and a stand. Then, the funnel body is positioned inside the stand such that it can securely hold a bouquet of flowers, allowing for a hands-free floral arrangement. Next, a ribbon is tightened around the stems of the flowers to securely form a bouquet that will not fall apart upon removal from the funnel body.

Accordingly, the flower funnel device of the present invention is particularly advantageous as it provides a device that permits the hands-free arrangement of flowers without risking damage to the flower heads. More specifically, the flower funnel body device can be placed on a flat surface and hold flowers fixed in place while a pre-placed ribbon is present and can be tightened around the stems, permitting safe removal from the funnel body. In this manner, the flower funnel device provides a solution to allowing a user to easily form a bouquet of flowers.

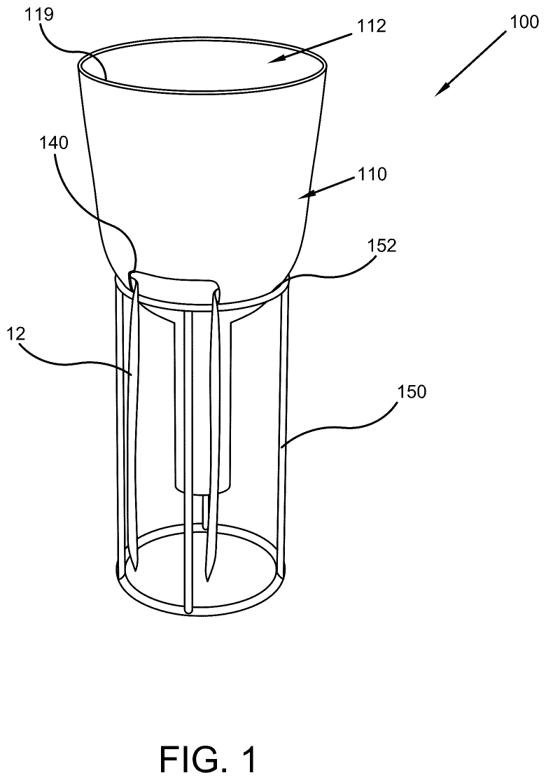

Referring initially to the drawings, FIG. 1 illustrates a perspective view of one potential embodiment of a flower funnel device 100 of the present invention in accordance with the disclosed architecture. The device 100 is comprised of a funnel body 110, a ribbon 12, and a stand 150. The device 100 is designed to be placed on a table or flat surface, while the funnel body 110 holds in place a bouquet of flowers 10, which is either fixedly or removably attached to the stand 150, and wherein the flower 10 can be secured together by the tying of a ribbon 12 around the stems of the flowers 10 once proper arrangement has taken place.

The funnel body 110 is preferably made from a plastic or silicone material that securely and easily maintains the shape of the desired flower arrangement 10 without fear of breaking, cracking, or falling. In differing embodiments, the funnel body 110 is preferably of a generally cone-like shape. In differing embodiments, the funnel body 110 may be comprised of transparent plastic material, such that the florist may be able to see the stems connected to the heads of the flowers for arrangement case.

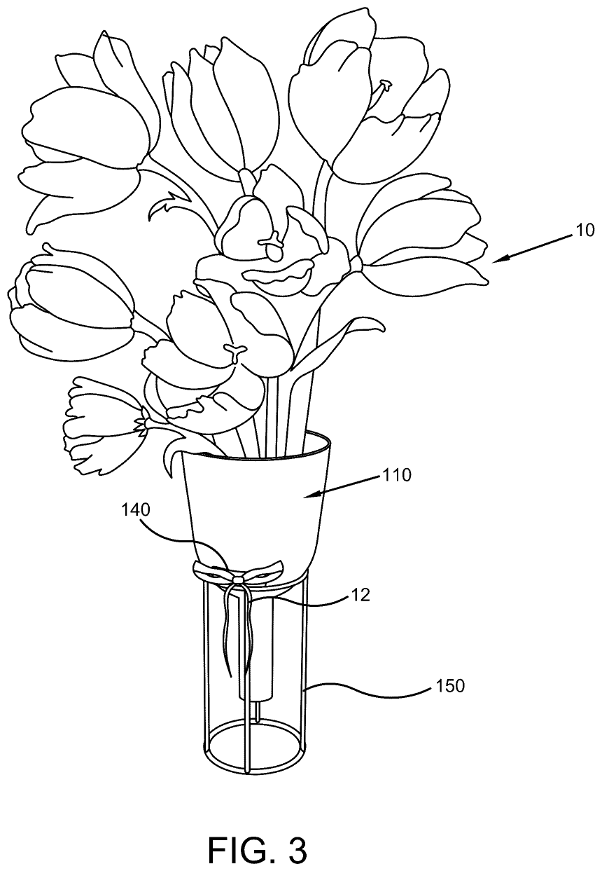

During use, the flowers 10 may be placed in the interior space 112 of the funnel body 110 via an opening 119, and their stems may be arranged in any such manner suitable to the florist. Furthermore, the funnel body 110 features at least one opening 140, where a ribbon 12 may drape down from. Once the flowers 10 have been placed inside the interior space 112 of the funnel body 110, the ribbon 12, being exposed through the opening 140, may be used to tie the stems of the flowers 10 together for secure arrangement, as seen in FIG. 3. The ribbon 12 may be comprised of any material capable of securely tying together the stems of flowers, including, but not limited to, twine, nylon, rope, cotton, elastic, or silk.

The device 100 also features a stand 150 that may be fixedly or removably attached to the funnel body 110. In one embodiment, the funnel body 110 can be placed partially through an opening 152 of the stand 150. The stand 150 may be of any shape that can be stably placed on a table or flat surface and is preferably of a weight that inhibits unwanted movement or falling during the arrangement process.

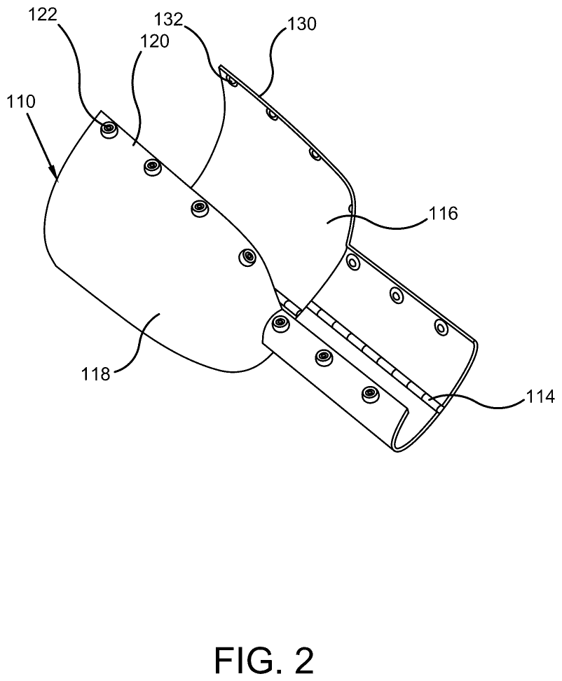

FIG. 2. Illustrates a perspective view of one potential embodiment of a flower funnel device 100 of the present invention in accordance with the disclosed architecture. In this potential embodiment, the device 100 features a funnel body 110 that is not one continuous piece. Instead, the body 110 has at least one hinge 114 with at least one fastener 122 on a bottom surface of a first edge 120, and at least one fastener 132 on a top surface 116 of a second edge 130, such that the flowers 10 may be removed from the funnel body 110 without being pulled out from the top, risking damage to the arrangement. The fasteners 122 and 132 may be comprised of any fastening mechanism known in the art, including, but not limited to, snap buttons, hook and loop, magnets, or any other reciprocating fastener type.

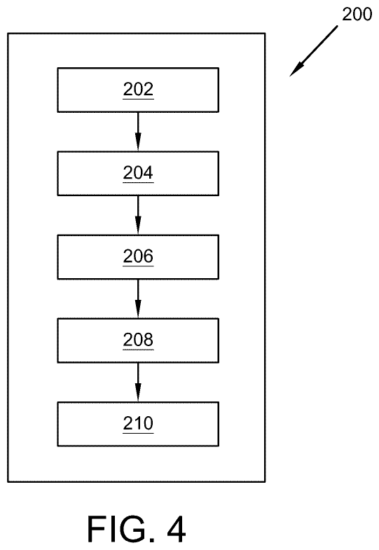

The present invention is also comprised of a method of using 200 the device 100, as seen in FIG. 4. First, a device 100 is provided comprised of a funnel body 110 comprised of a first opening 119 and a second opening 140, a ribbon 12, and a stand 150 [Step 202]. Then, the funnel body 110 is positioned inside of/attached to the stand 150 such that it can securely hold a bouquet of flowers 10 [Step 204]. Then, a user can arrange at least one flower 10 inside of the body 110 freely [Step 206]. Next, at least one ribbon 12 is pulled through an opening 140 of the body 110 and tightened around the stems of the flowers 10 to securely form a bouquet that will not fall apart upon removal from the funnel body 110 [Step 208]. Finally, a user can remove the flowers 10 (in tied bouquet form) by pulling the flowers upward from the body 110 [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “flower funnel device” and “device” are interchangeable and refer to the flower funnel device 100 of the present invention.

Notwithstanding the foregoing, the flower funnel device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the flower funnel device 100 as shown in the FIGS. are for illustrative purposes only, and that many other sizes and shapes of the flower funnel device 100 are well within the scope of the present disclosure. Although the dimensions of the flower funnel device 100 are important design parameters for user convenience, the flower funnel device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A flower funnel device comprising:
a body comprised of an interior space, a first opening, and a second opening; and
a stand that receives the body.

2. The flower funnel device of claim 1, wherein the body is comprised of a cone shape.

3. The flower funnel device of claim 1, wherein the body is fixedly attached to the stand.

4. The flower funnel device of claim 1 further comprised of a ribbon.

5. A flower funnel device comprising:
a body comprised of an interior space, a first opening, and a second opening; and
a stand comprised of an opening that receives the body.

6. The flower funnel device of claim 5, wherein the body removably attaches to the stand.

7. The flower funnel device of claim 5 further comprised of a ribbon.

8. The flower funnel device of claim 5, wherein the body is comprised of a first fastener.

9. The flower funnel device of claim 8, wherein the first fastener is comprised of a snap button fastener, a hook and loop fastener, or a magnet fastener.

10. The flower funnel device of claim 8, wherein the first fastener is positioned on a first edge of the body.

11. The flower funnel device of claim 9, wherein the first edge is located on a bottom surface of the body.

12. The flower funnel device of claim 5, wherein the body is comprised of a second fastener.

13. The flower funnel device of claim 12, wherein the first fastener is comprised of a snap button fastener, a hook and loop fastener, or a magnet fastener.

14. The flower funnel device of claim 11, wherein the second fastener is positioned on a second edge of the body.

15. The flower funnel device of claim 12, wherein the second edge is located on a top surface of the body.

16. The flower funnel device of claim 5, wherein the body is comprised of a hinge.

17. A method of using a flower funnel device, the method comprising the following steps:
providing a flower funnel device comprised of a body comprised of a first opening and a second opening, a ribbon, and a stand;
placing a flower inside the body;
pulling the ribbon through the second opening and tightening the ribbon around the flower; and
removing the flower from the body.

18. The method of using a flower funnel device of claim 17, wherein the body is removably attached to the stand.

19. The method of using a flower funnel device of claim 17, wherein the body is comprised of a cone shape.

20. The method of using a flower funnel device of claim 17, wherein the body is comprised of a hinge, a first fastener, and a second fastener.
